(19) United States
(12) Patent Application Publication
(10) Pub. No.: US 2026/0061891 A1
(43) Pub. Date: Mar. 5, 2026

(54) COVERING DEVICE FOR COVERING A RAIL OF A LONGITUDINAL ADJUSTER, LONGITUDINAL ADJUSTER FOR A VEHICLE SEAT, AND VEHICLE SEAT

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 19/105,857

(22) PCT Filed: Feb. 2, 2023
(86) PCT No.: PCT/IB2023/050909

§ 371 Date: Feb. 24, 2025

(30) Foreign Application Priority Data
Aug. 25, 2022 (DE) 10 2022 208 807.7

(51) Int. Cl. B60N 2/07

(52) U.S. Cl. CPC B60N 2/0722

(57) ABSTRACT

A covering device for covering a rail of a longitudinal adjuster for a vehicle seat, may have a cover having an opening. The opening can be at least partly closed by means of at least one cover element which is guided in the cover, and at least one protective unit for protecting the cover element. The device also relates to a longitudinal adjuster and a vehicle seat.

The invention relates to a covering device covering a rail of a longitudinal adjuster for a vehicle seat, having the features of the preamble of claim 1. The invention furthermore relates to a longitudinal adjuster for a vehicle seat, in particular motor vehicle seat, having the features of the preamble of claim 11, and to a vehicle seat.

### PRIOR ART

DE 10 2016 224 588 A1 has disclosed a longitudinal adjuster having a rail assembly, comprising a lower rail and an upper rail that is movably connected to the lower rail. Said document also discloses a covering (for example a rubber covering, a brush-type covering etc.) which is connected to an outer profile of the lower rail and which is arranged so as to cover at least a part of an inner profile. The covering may comprise a rubber strip which is connected to the outer profile and which is arranged on an upper part of each side of the inner profile. The covering may generally extend parallel to a longitudinal axis of the inner profile. The covering covers at least a part of the corresponding intermediate spaces of the lower rail. The covering serves to limit/prevent the ingress or falling of dirt and/or fabric into corresponding intermediate spaces of the lower rail.

EP 1 209 024 A1 and EP 1 207 073 A1 have disclosed longitudinal adjusters for vehicle seats, which longitudinal adjusters have a lower rail fastened to a vehicle floor and have an upper rail attached movably to the lower rail. The longitudinal adjusters have a covering faceplate which is formed from a synthetic resin material and which, on an inner side, has two soft lip portions that form a gap.

JP H10-315 809 A has disclosed a longitudinal adjuster for a vehicle seat, which longitudinal adjuster has an elongate lower rail, which is fastened to a vehicle floor, and an upper rail which is attached to a seat and which is mounted movably on the lower rail. On an upper surface of the lower rail, there are provided two longitudinal elastic covers which bear loosely against one another and through the contact gap of which the upper rail passes.

### PROBLEM

The invention addresses the problem of improving a covering device for covering a rail of a longitudinal adjuster of the type mentioned in the introduction, in particular of providing a durable covering device for a rail which completely prevents an ingress of foreign bodies or other disruptive items. The invention also addresses the problem of providing a longitudinal adjuster for a vehicle seat, in particular a longitudinal adjuster having a durable cover for upwardly open regions of a rail of the longitudinal adjuster, and of providing a corresponding vehicle seat.

### SOLUTION

Said problem is solved according to the invention by a covering device for covering a rail of a longitudinal adjuster for a vehicle seat, wherein the covering device has a faceplate having an opening, wherein the opening is at least partially closable by a covering element with rolling-up capability which is guided in the faceplate. According to the invention, the covering device has at least one protective unit for protecting the covering element, in particular for safeguarding a rolling-up function and an unrolling function of the covering element with rolling-up capability.

By virtue of the fact that at least one protective unit is provided for safeguarding the covering element with rolling-up capability, in particular the rolling-up function and unrolling function thereof, a malfunction of the covering element with rolling-up capability is avoided.

The covering device serves in particular for covering a long rail, in particular a long floor rail, which extends for example in the longitudinal direction of a vehicle, for example a van, over two or more rows of seats. The covering device is provided for the purposes of avoiding contamination of the long rail and in particular of a spindle arranged in said long rail. The long rail allows for example a range of adjustment of 600 mm or more for a carriage or a top rail that is connected to one of the adjustable seats.

The subclaims relate to advantageous embodiments that may be used individually or in combination with one another.

A first protective unit is for example formed as a support unit that is arranged in particular directly under an underside of an unrolled covering element. The first protective unit may in particular be an outer protective unit which may be arranged outside a cassette for the covering element and for example within a rail of a longitudinal adjuster.

For example, the support unit is arranged with a predefined spacing to the underside of the unrolled covering element such that, during normal operation, the covering element is able to be rolled up or unrolled without friction and makes contact with the support unit when a mechanical load acts on the surface of the covering element.

Undesired deformation of the covering element, for example owing to articles falling onto or objects, such as the heel of a shoe, acting upon the covering element, can be substantially avoided by way of such contact between the covering element and support unit. In particular, a permanent deformation of the covering element after misuse, for example as a result of the action of a high-heeled shoe upon the unrolled covering element, can be avoided by way of a support unit on the underside of the covering element.

For example, the support unit is formed as a molded body or block body, for example a solid molded body, consisting for example of plastics material, or as a profiled element, for example a metal bracket or plastics bracket.

The at least one support unit may for example be provided in certain regions for the purposes of safeguarding the covering element. For example, the support unit may be provided and arranged in free spaces formed on an underside of the unrolled covering element when the covering element is in the extended or unrolled state (also referred to as extended, rolled-out or unwound covering element). For example, the support unit may be arranged in a free space formed between a spindle end and a rolling-up cassette of the covering element.

A second protective unit may for example be formed as a wiper unit (also referred to as wiper). The second protective unit may in particular be formed as an inner protective unit, which is arranged within the cassette for the covering element, and/or as an outer protective unit, which is arranged outside the cassette for the covering element. The wiper unit may in particular be arranged so as to wipe or sweep a surface of the covering element, in particular in order to at least partially remove dirt from the surface of the covering element. It is thus not possible for dust particles or dirt particles to enter a rail that is covered by the covering device, in particular a lower rail and/or a spindle arranged in said rail. Furthermore, disturbing noises and scratches on the surface of the covering element can be avoided by way of such a wiper unit.

The wiper unit may for example be arranged in a region of an entrance of a cassette and/or within a cassette for the covering element. An outer wiper unit, arranged in particular outside the cassette, can wipe dirt off the covering element already before it reaches the cassette. Alternatively or in addition, the wiper unit may be integrated, as an inner wiper unit, into the cassette. In particular, the wiper unit may be integrated into a cassette base. For example, the wiper unit is integrated in an opening in the cassette base. Here, the inner wiper unit is configured such that dirt that is wiped off the covering element by said wiper unit is able to be discharged from the cassette via the opening.

The wiper unit may for example be configured in the form of a brush that is always in contact with the covering element, in particular with a surface of a roll spring. The wiper unit may furthermore be provided and configured such that noises between the rolled-up spring regions of the roll spring are avoided.

The wiper unit may in particular be arranged so as to always be in contact with the covering element, for example with the surface of a roll spring, in particular of a constant spring or of a spiral spring, irrespective of whether the covering element is rolled up (also referred to as wound up) or unrolled (also referred to as unwound or rolled out).

For example, the wiper unit is arranged so as to wipe or sweep a surface of an unrolled covering element (referred to as rolled-out or unwound covering element) before it is rolled up again.

Alternatively or in addition, the wiper unit may be arranged so as to wipe or sweep a surface of a rolled-up covering element (also referred to as wound-up covering element) before it is unrolled (also referred to as rolled out or unwound).

The wiper unit may for example be of flexible form. For example, the wiper unit is in the form of a spring arm. The spring force of the wiper unit is for example configured such that the wiper unit is always in contact with the surface of the covering element. In addition or alternatively, the wiper unit may also establish the permanent contact with the covering element by way of a geometry and elasticity. For example, the wiper unit is formed as a plastics spring element. Furthermore, an additional spring may be provided for the wiper unit, which additional spring generates a constant spring force for maintaining the permanent contact with the covering element irrespective of temperature fluctuations.

The wiper unit may furthermore have a wiper lip or a wiper edge that is in contact with the surface of the covering element. The wiper unit may have a flexible arm or the spring arm, on the free end of which the wiper lip or the wiper edge is provided, which is in contact, in particular in permanent contact, with the surface of the covering element. For example, the wiper lip is formed as a sharp wiper lip. In particular, the wiper lip may be formed as a sharp rubber lip. The wiper edge may be formed as a sharp wiper edge. Alternatively, the wiper edge may be formed as a brush edge and equipped with bristles. In particular, the wiper lip extends transversely with respect to the rolling-up direction or unrolling direction of the covering element and over the entire width of the covering element. The covering element can thus be cleared of dirt over its entire width.

The problem addressed is furthermore solved according to the invention by a longitudinal adjuster for a vehicle seat, in particular motor vehicle seat. The longitudinal adjuster has at least one first rail and at least one second rail arranged so as to be movable relative to the first rail, wherein the first rail has a covering device according to the description above.

The first rail may be a floor rail that is able to be recessed into a vehicle floor. The first rail may be a rail which is lengthened in relation to the second rail (and which is also referred to as long rail). The first rail may have a base portion. The first rail may have two limbs that protrude at opposite sides of the base portion. The first rail may, at those ends of the limbs which are remote from the base portion, have end portions that are bent back inwardly. The first rail may have a substantially U-shaped cross section.

The longitudinal adjuster may have a spindle drive, arranged between the first rail and the second rail, for moving the second rail relative to the first rail. The spindle drive may have a spindle. The spindle may have an external thread. The spindle drive may have a gear mechanism that is drivable by a motor. The gear mechanism may be held in the second rail.

In a first embodiment of the spindle drive, the spindle may be held fixedly in the first rail by two spindle holders. The spindle may be held so as to be rotationally fixed. The gear mechanism may have a spindle nut which has an internal thread operatively connected to the external thread of the spindle. The gear mechanism may be movable along the spindle by being driven by the motor.

In a second embodiment of the spindle drive, the spindle may be connected rotationally conjointly, at an end portion of the spindle, to the gear mechanism. The spindle drive may have a spindle block which is fixed in the first rail and which has an internal thread and which is operatively connected to the external thread of the spindle. The spindle may be screwed rotatably into the spindle block. The spindle block may be movable along the driven spindle.

The covering device may, together with the first rail of the longitudinal adjuster, be installable in recessed fashion in a vehicle floor such that substantially only an upper region of the faceplate of the covering device is visible in the vehicle. The first rail may be laterally at least partially surrounded by the faceplate. The first rail may be covered by the faceplate. The second rail, which is supported movably in the first rail, may preferably project upwardly out of the opening of the faceplate in the direction of the vehicle seat. The opening of the faceplate in front of and behind the second rail is coverable by the covering element. The covering element may be formed as a roll spring, in particular a constant force spring or spiral spring, which is able to be pulled out of a cassette situated at an end of the first rail. The roll spring may be guided to the side of and above the first rail. The roll spring may be coupled to the second rail (also referred to as upper rail, runner or carriage) in order to follow the movement thereof and cover or close the opening in the faceplate of the first rail (also referred to as lower rail or floor rail).

The problem addressed is furthermore solved according to the invention by a vehicle seat having a longitudinal adjuster according to the description above.

A guide which surrounds the first rail (lower rail) may have lateral guide tracks in which the covering element, in particular a roll spring, is laterally guided. The guide is preferably situated above the first rail and supported thereon (also in the event that the faceplate is stepped on by a vehicle occupant).

It is furthermore preferable if a cassette (also referred to as receiving chamber or rolling-up cassette) for the covering element formed as a roll spring is situated at each of the two ends of the rail. These two roll springs are each able to be mounted at a first end within the cassette. The roll springs may have a tendency to relax and, in a rolled-up state, to always assume a maximum diameter. A position of the roll spring within the cassette may be predefined by rollers or struts.

A second end of each roll spring may be fastened, in particular mounted, on the second rail. If one of the roll springs is pulled owing to a change in position of the second rail, the roll spring is able to be pulled out of the cassette. The roll spring may be capable of being rolled out or unrolled (also referred to as unwound) about a mounting point, with the diameter of the roll spring accordingly being reduced. In the event of a backward movement of the second rail in the direction of the cassette in question, the roll spring is able to be rolled up in, or rolled into, the cassette owing to a spring force of the roll spring. The roll spring is arranged so as to roll into the cassette automatically.

The proposed solution has the advantage that a continuous faceplate having a dimensionally stable covering element, which is able to be rolled up or unrolled quietly, is provided.

If in each case one covering element in the form of a roll spring is provided toward the front and toward the rear in the longitudinal direction, the forces exerted by each of the covering elements on the second rail cancel one another out, such that an adjusting force of a longitudinal adjuster according to the invention is not increased in relation to longitudinal adjusters that do not have a covering device according to the invention.

In summary, and in other words, as a first protective unit, a support unit is provided under the covering element, in particular under the roll spring or under the covering spring, in order to prevent permanent deformation of the covering element, which is formed for example as a thin metal strip, after misuse (for example bending or deformation caused by a high-heeled shoe). In regions in which a spindle of the power drive system is arranged, support is provided by the spindle of the power drive system. Additional support is required in regions in which no spindle is present. In other words: Support is required only in regions of the first rail or lower rail or floor rail in which no spindle or other component such as a spindle holder, spindle nut or the like is arranged, because the spindle itself or the associated components themselves serve as such a support if the spacing between the spindle and the covering element (roll spring or covering spring) or between the associated component and the covering element is not excessively large. The support unit (also referred to for short as support) may be implemented by metal brackets or plastics parts which are connected to the lower profile, in particular to the floor rail or lower rail (first rail).

A dust wiper (wiper unit) is provided as a second protective unit at the covering element with rolling-up capability (also referred to as roll-type covering with a constant force spring). The wiper is always in contact with the roll spring, in particular a spiral spring consisting of a spring steel strip, irrespective of whether said roll spring is wound up or unwound. This is implemented by a spring force. The roll spring may be produced directly by the geometry of the wiper, in particular of a plastics spring element. Also conceivable is an additional spring that generates a constant spring force irrespective of temperature fluctuations. It is therefore not possible for dust particles or dirt particles to enter the floor rail or lower rail and reach the spindle. The wiper itself makes contact over the entire width of the spring winding. Said wiper has a sharp wiper edge in order to reliably remove dirt.

### FIGURES AND EMBODIMENTS OF THE INVENTION

The invention will be discussed in more detail below on the basis of advantageous exemplary embodiments illustrated in the figures. The invention is however not restricted to these exemplary embodiments. In the figures:

FIG. 1: is a schematic illustration of a vehicle seat according to the invention,

FIG. 2: is a perspective illustration of a detail of the covering device according to the invention,

FIG. 3: is a longitudinal sectional view of a detail of the covering device in the region of a storage device for a covering element of the covering device,

FIG. 4: is a longitudinal sectional view of a detail of a further exemplary embodiment of a covering device in the region of a captive storage means for a covering element of the covering device,

FIG. 5: is a cross-sectional view of a covering device installed on a rail of a longitudinal adjuster,

FIG. 6: is a perspective illustration of the covering device according to the invention installed on a rail arrangement of a longitudinal adjuster,

FIG. 7: is a sectional perspective illustration of a detail of the covering device according to the invention having protective units designed as a support unit and as a wiper unit,

FIG. 8: is a sectional illustration of the covering device according to the invention having protective units designed as a support unit and as a wiper unit and installed on the rail arrangement,

FIG. 9: is a sectional illustration of the covering device according to the invention having protective units designed as a support unit and as a wiper unit, without the rail arrangement being illustrated,

FIG. 10: is a sectional perspective illustration of a detail of the covering device according to the invention installed on the rail arrangement, with an installed drive unit,

FIG. 11: is a sectional illustration of a detail of the covering device according to the invention, omitting the rail arrangement according to FIG. 10 and illustrating the drive unit according to FIG. 10,

FIG. 12: is a sectional illustration of a cassette with a rolled-up covering element and with a wiper unit for the covering element, and

FIG. 13: is an enlarged view of the sectional illustration according to FIG. 12 in the region of the wiper unit.

Mutually corresponding parts are denoted by the same reference designations throughout the figures.

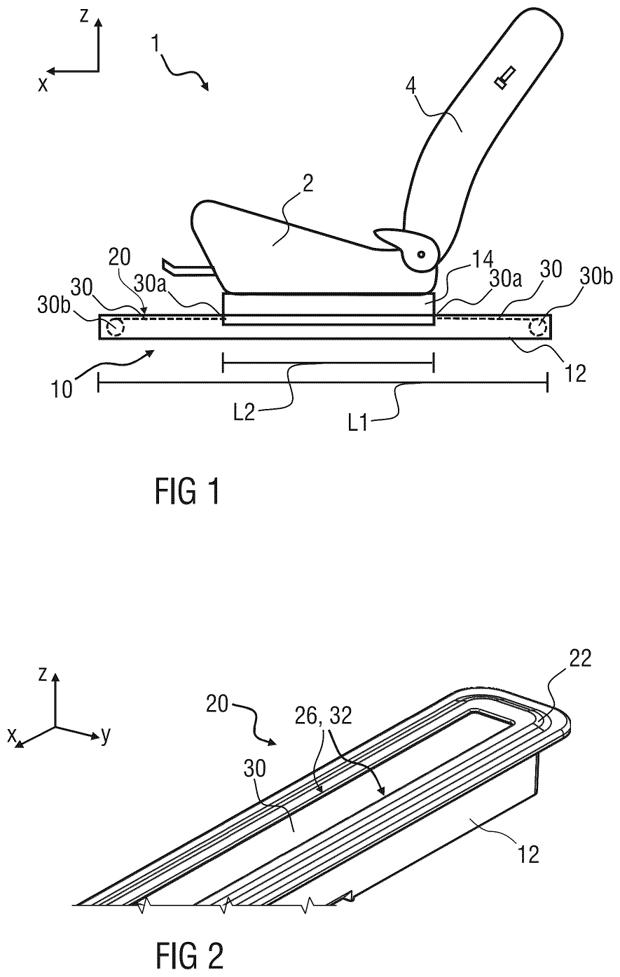

A vehicle seat 1 that is schematically illustrated in FIG. 1 will hereinafter be described with reference to three mutually perpendicular spatial directions. In the case of a vehicle seat 1 that has been installed in the vehicle, a longitudinal direction x runs substantially horizontally and preferably parallel to a vehicle longitudinal direction that corresponds to the normal direction of travel of the vehicle. A transverse direction y, which runs perpendicular to the longitudinal direction x, is likewise oriented horizontally in the vehicle and runs parallel to a vehicle transverse direction. A vertical direction z runs perpendicular to the longitudinal direction x and perpendicular to the transverse direction y. In the case of a vehicle seat 1 that has been installed in the vehicle, the vertical direction z runs parallel to the vehicle vertical axis.

The position terminology and directional terminology used, such as front, rear, top and bottom, relate to a viewing direction of an occupant seated in a normal sitting position on the vehicle seat 1, with the vehicle seat 1 having been installed in the vehicle in a usage position suitable for conveying passengers, having an upright backrest 4, and being oriented in a direction of travel in the conventional manner.

The vehicle seat 1 may however also be installed in a different orientation, for example transversely with respect to the direction of travel.

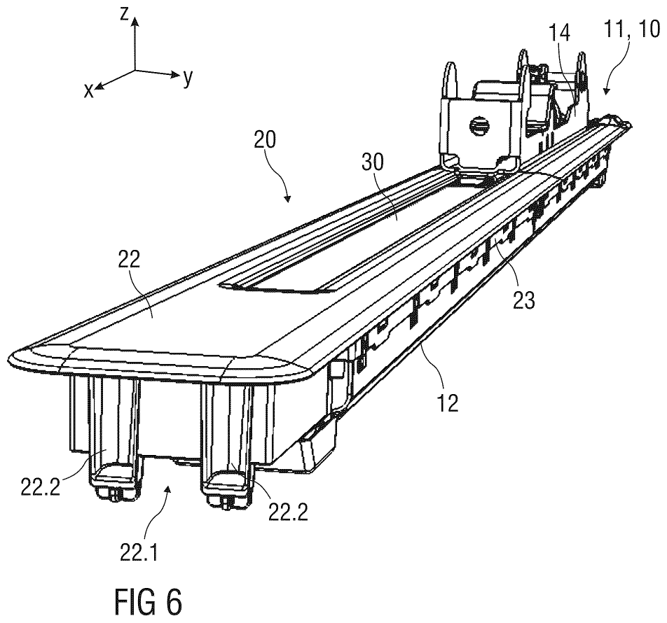

The vehicle seat 1, in particular motor vehicle seat, has a seat part 2 and the backrest 4. The backrest 4 is adjustable in terms of its inclination relative to the seat part 2. The vehicle seat 1 has a longitudinal adjuster 10 for the adjustment of a seat longitudinal position. The longitudinal adjuster 10 has, as a rail assembly 11 (illustrated in FIG. 6), at least one first rail 12 and at least one second rail 14 arranged so as to be movable relative to the first rail 12. The seat part 2 is in this case connected, in particular screwed, to the second rail 14 of the longitudinal adjuster 10. A seat height adjustment device (not illustrated) may furthermore be arranged between the seat part 2 and the second rail 14 of the longitudinal adjuster 10.

The longitudinal adjuster 10 has in this case a second rail 14 having a length L2, wherein a length L1 of the first rail 12 is greater than the length L2 of the second rail 14, and in particular, the length L1 of the first rail 12 corresponds to a multiple of the length L2 of the second rail 14. The first rail 12 is also referred to as long rail. The second rail 14 is also referred to as runner or carriage. The present longitudinal adjuster 10 is a longitudinal adjuster 10 having a lengthened adjustment travel in relation to a conventional device for seat longitudinal adjustment, with a larger range of adjustment for the vehicle seat 1 or for a plurality of vehicle seats 1 that are fastenable to the first rail 12.

The first rail 12 and the second rail 14 of the longitudinal adjuster 10 can form a first rail pair. The longitudinal adjuster 10 may have a second rail pair (not shown in the figures in order to provide a clearer illustration) that is preferably arranged symmetrically with respect to the first rail pair.

A covering device 20 is provided for covering open regions of the first rail 12 (lower rail).

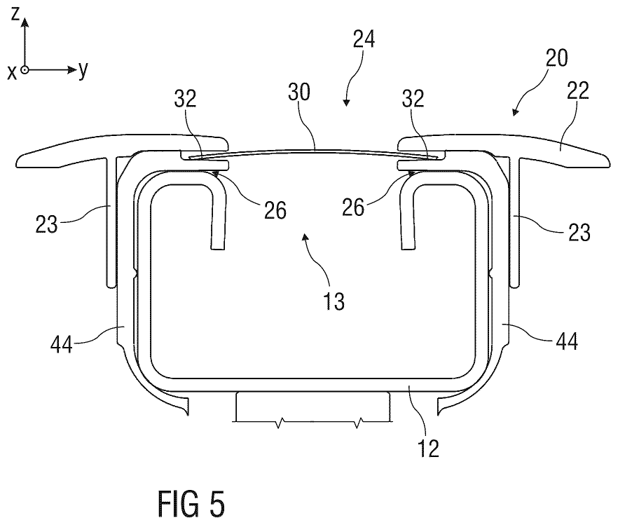

The covering device 20 comprises at least one covering element 30 that covers a region of a rail opening 13 (illustrated in FIG. 5) of the first rail 12 not covered by the second rail 14. The covering element 30 is for this purpose designed as an element with rolling-up capability in order that, during a movement of the second rail 14 relative to the first rail 12, said covering element correspondingly variably covers said first rail, in particular the rail opening 13 (illustrated in FIG. 5) thereof.

In the exemplary embodiment in FIG. 1, the covering device 20 comprises two covering elements 30, which are each fastenable or detachably fastened by way of a first end 30a to the ends of the second rail 14 and supported by way of a second end 30b on associated ends of the first rail 12 so as to be capable of being rolled up.

FIG. 2 is a perspective illustration of a detail of the covering device 20 according to the invention.

The first rail 12, in particular a lower rail, comprises a faceplate 22 in the direction of the second rail 14. The faceplate 22 is designed as a faceplate frame that encircles the, in particular elongate or slot-like, rail opening 13 (illustrated in FIG. 5) of the first rail 12. The faceplate 22 is situated above or on the first rail 12. The faceplate 22 may thus be supported on the first rail 12. The faceplate 22 may additionally cover side regions of the first rail 12.

The faceplate 22 may be a plastics element, in particular a plastics faceplate. The first rail 12 is formed in particular as a profiled component, in particular as a metal profiled component.

To cover the rail opening 13 (illustrated in FIG. 5), the covering device 20 comprises the covering element 30, which is shown in FIG. 2 in the unrolled or rolled-out state, and thus in the state in which it covers the rail opening 13.

The faceplate 22 may be equipped with an integrated, in particular integrally formed, guide channel 26 or with a separate guide channel 26. The guide channel 26 may be formed only to the sides, in particular at opposite longitudinal sides, of the faceplate 22.

The guide channel 26 serves for guiding the covering element 30 during the adjustment of the vehicle seat 1. The guide channel 26 is situated above or on the first rail 12.

The covering element 30 has an outer edge portion 32. The lateral outer edge portions 32 of the covering element 30, in particular lateral outer edge portions 32 extending along the longitudinal extent of the covering element 30, are guided for example by the lateral guide channels 26 of the faceplate 22 as the covering element 30 is rolled up or unrolled.

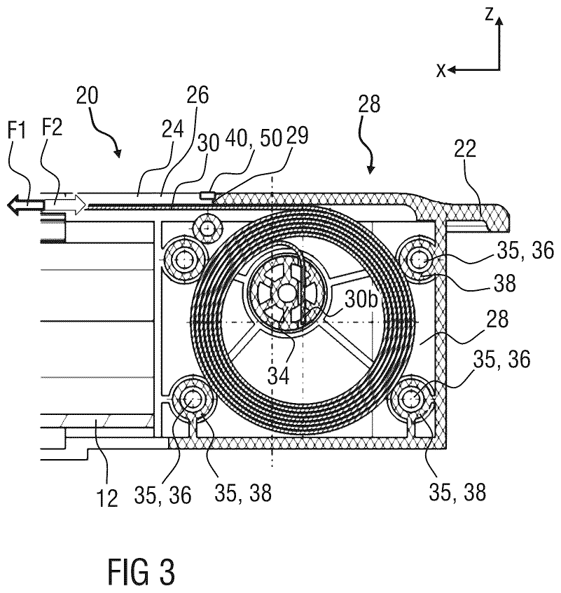

FIG. 3 shows a longitudinal section of a detail of the covering device 20 in the region of a storage device, in particular a cassette 28, for receiving the covering element 30 in the rolled-up state.

In the present case, the covering device 20 has a first cassette 28, in which a covering element 30 is provided, at a rear end of the first rail 12 in the longitudinal direction x. The covering device 20 preferably has a second cassette 28, which is structurally identical to the first cassette 28 but constructed or arranged mirror-symmetrically with respect to the first cassette 28, at a front end of the first rail 12 in the longitudinal direction x. The second cassette 28 has a corresponding further covering element 30. The following description, which refers generally to “the cassette 28”, applies both to the first cassette 28 and to the structurally identical second cassette 28.

The cassettes 28 may be arranged at the end faces of the first rail 12. The cassettes 28 may alternatively also be arranged within the first rail 12 in the front end and the rear end thereof. In a further alternative, the covering elements 30 are provided without cassettes 28. For this purpose, it is for example possible for corresponding rolling-up elements, in particular rollers, diverting rollers or struts, to be arranged, in particular integrated, for example integrally formed, within the first rail 12 at the front end and at the rear end.

The first end 30a of the covering element 30 is connected to the second rail 14 (illustrated in FIG. 1), in particular is mounted in a receptacle in the second rail 14. In the cassette 28 assigned to the covering element 30, the second end 30b of the covering element 30 is connected to a holding device 34.

The covering device 20 serves for covering one of the rails 12, 14 of the longitudinal adjuster 10, in particular the rail opening 13 of the first rail 12 (illustrated in FIG. 5). The covering device 20 has the faceplate 22, which has an opening 24. The covering device 20 is installable in recessed fashion in a vehicle floor such that only an upper region of the faceplate 22 is visible in the vehicle. The faceplate 22 is an external plastics faceplate.

The first rail 12 may additionally be laterally at least partially surrounded and covered by the faceplate 22. The second rail 14, which is supported movably in the first rail 12, projects upwardly out of the opening 24 of the faceplate 22 in the direction of the vehicle seat 1. Arranged to each of the two sides of the opening 24 is the guide channel 26 for guiding and holding the associated edge portion 32 of the covering element 30. The guide channel 26 is configured in the manner of a slot in the faceplate 22, as shown in detail for example in FIG. 5.

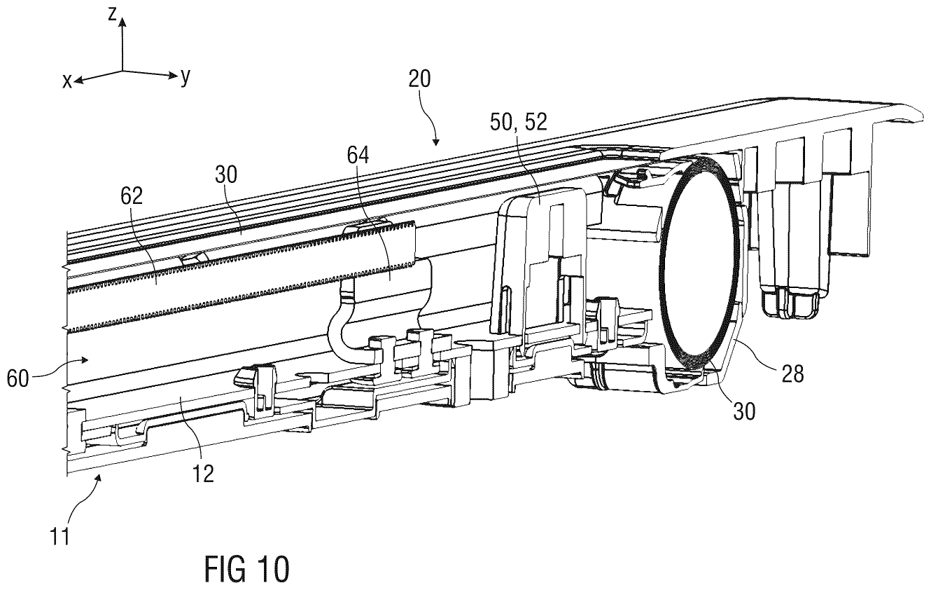

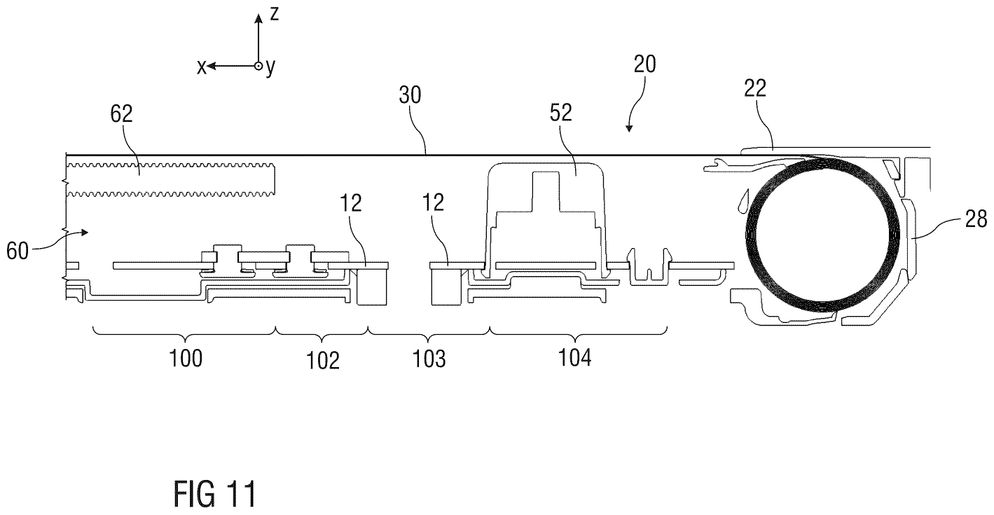

Both the opening 24 of the faceplate 22 and the rail opening 13 of the first rail 12 are partially closable by the covering element 30 guided in the faceplate 22. The at least partial coverage of the opening 24 and of the rail opening 13 by the covering element 30 has the effect, for example, that a view of a spindle 60, arranged in the interior of the first rail 12, of an electric adjusting device (illustrated in FIGS. 10 and 11) is obstructed.

As illustrated in FIG. 3, the opening 24 of the faceplate 22 may extend above the cassette 28 to a small extent. The cassette 28 is substantially upwardly closed, preventing an ingress of dirt or the like into the cassette 28. The fixedly covered cassette 28 furthermore has the advantage that the covering element 30 cannot be inadvertently pushed downward in the cassette 28 by an external load.

The covering element 30 is arranged in the associated cassette 28 in a rolled-in or wound-up or rolled-up state. In an entrance region of the cassette 28, the faceplate 22 preferably has a wiper element 40 as a protective unit 50 for the covering element 30. The wiper element 40 is in the present case a brush or a wiper lip, in particular a rubber lip. The wiper element 40 is in contact with a surface of the covering element 30. The wiper element 40 thus prevents an ingress of dirt into the cassette 28 when the covering element 30 is pulled or pushed into the cassette 28.

The covering element 30 is preferably resiliently elastic. The covering element 30 is in the present case configured as a roll spring.

The holding device 34 is in the present case a cylindrical shaft. The holding device 34 is arranged fixedly in the cassette 28. The holding device 34 may alternatively or additionally be supported so as to be rotatable. The holding device 34 is arranged eccentrically in the cassette 28. The holding device 34 has a receptacle for the fastening of the second end 30b of the coupling element 30, in particular a slot for mounting the second end 30b.

A number of support elements 35, in particular a plurality of struts 36 with rollers 38 arranged rotatably thereon, are arranged in the cassette 28. The support elements 35 serve for guiding and supporting the covering element 30 as it is rolled up or unrolled. The struts 36 having the rollers 38 are preferably arranged in corner regions of the cassette 28 as viewed in the transverse direction y. The struts 36 having the rollers 38 serve for guiding or supporting the covering element 30. As it is rolled into the cassette 28, the covering element 30 is able to be diverted onto a corresponding circular path by the struts 36 or the rollers 38.

The covering element 30, in particular in the form of a constant force spring, in particular a roll spring, has a tendency to relax and to always assume a maximum diameter in a rolled-up state. The covering element 30 is able to be pulled out of the cassette 28, in particular through a slot-like housing opening 29, by a force F1 introduced by the second rail 14. In the opposite direction, the covering element 30 is able to be pulled or pushed into the cassette 28 by a force F2. The force F2 preferably results from an elastic preload of the covering element 30 designed as a roll spring.

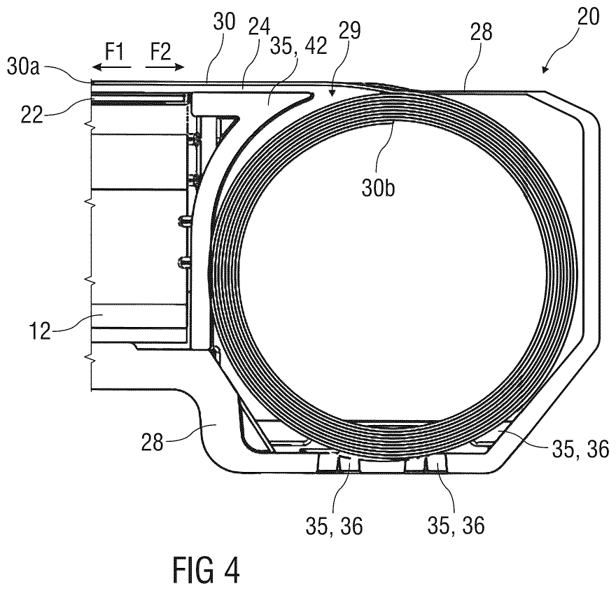

FIG. 4 is a longitudinal sectional view of a detail of a further exemplary embodiment of a covering device 20 in the region of a captive storage means for a covering element 30 of the covering device 20.

The covering element 30 may be resiliently elastic. The covering element 30 may be a constant force spring, in particular a roll spring.

The covering element 30 is arranged captively in a cassette 28. A first end 30a of the covering element 30 may be connected to the second rail 14, as described above. For the captive arrangement of the covering element 30 in the cassette 28, the covering element 30 has a corresponding length longer than a predefined required unrolled length for covering the first rail 12. In this case, a second end 30b of the covering element 30 may be arranged in the cassette 28 without any fastening. Owing to its restoring force, the covering element 30 in the form of a constant force spring is held in a rolled-up state in the cassette 28.

The spring force of the covering element 30 is furthermore dimensioned such that, even as it is being unrolled or rolled up, the covering element 30 is supported captively in the cassette 28. Furthermore, the cassette 28 may, at least on the inside, have such a shape and/or such dimensions that, both in the rolled-up state and as it is being rolled up or unrolled, the covering element 30 is supported captively in the cassette 28. For example, the cassette 28 may have internal support elements 35, in particular arcuate projections 42 and/or struts 36, for guiding and supporting the covering element 30 in the cassette 28. The cassette 28 comprises a housing having a housing opening 29, in particular a slot-like housing opening 29, which is directed toward the upper second rail 14 and through which the free end 30a of the covering element 30 is led out. The housing opening 29 is dimensioned such that, both in the fully rolled-up state and in the unrolled state with a predefined unrolled length, the covering element 30 is supported captively in the cassette 28.

The covering element 30, in particular the second end 30b of the covering element 30, may alternatively or additionally be held in the cassette 28 by a fastening or by the above-described holding device 34. For example, the second end 30b of the covering element 30 may be detachably fastened to an inner wall of the cassette 28, for example interlockingly attachable to, in particular clamped on, a holding projection, a detent lug or a holding groove.

FIG. 5 shows a cross section of the covering device 20 installed on the first rail 12 of the longitudinal adjuster 10.

The covering device 20 serves for covering the first rail 12. In particular, an upwardly directed rail opening 13 is covered by the covering element 30 in the unrolled state.

The covering device 20 has the faceplate 22, which has the opening 24. The covering device 20 is installable in recessed fashion in a vehicle floor, and installable on the first rail 12, such that only an upper region of the faceplate 22 is visible in the vehicle. The faceplate 22 is an external plastics faceplate.

The first rail 12 may additionally be laterally at least partially surrounded and covered by the faceplate 22. For this purpose, the faceplate 22 has extensions 23 which project vertically in the direction of the first rail 12. The extensions 23, for example in the form of walls, extend in the longitudinal direction x laterally with respect to, in particular on both longitudinal sides of, the first rail 12.

Arranged to each of the two sides of the opening 24 in the faceplate 22 is a guide channel 26 for guiding and holding the associated edge portion 32 of the covering element 30. The guide channel 26 is configured in the manner of a slot in the faceplate 22. Two guide channels 26 are provided, which extend in the longitudinal direction x laterally with respect to, in particular on both longitudinal sides of, the faceplate 22.

Here, each guide channel 26 may be formed on the underside of the faceplate 22. Alternatively, as illustrated, the covering device 20 may comprise not only the faceplate 22 but also a side covering 44 for the first rail 12, which side covering is arranged laterally with respect to the first rail 12 and under the faceplate 22. The guide channel 26 may be configured in the form of a longitudinal groove or a cutout on that end of the side covering 44 which is directed toward the faceplate 22, as illustrated in FIG. 5.

The opening 24 is partially closable by the covering element 30 that is guided in the faceplate 22. The at least partial coverage of the opening 24 by the covering element 30 has the effect, for example, that a view of a spindle, arranged in the interior of the first rail 12, of an electric adjuster is obstructed.

FIG. 6 is a perspective illustration of the covering device 20 according to the invention installed on a rail arrangement 11 of the longitudinal adjuster 10. The rail arrangement 11 comprises the first rail 12 and the second rail 14.

The covering device 20 is shown in an unrolled state of the covering element 30, the first end 30a (illustrated in FIG. 1) of which is designed, together with the second rail 14, to close or cover the opening 24 of the faceplate 22 and the rail opening 13 (illustrated in FIG. 5). The faceplate 22 may comprise fastening elements 22.2 at its longitudinal ends 22.1, in particular longitudinal end faces. The covering device 20, when installed in the vehicle, can be arranged and fastened, in particular recessed and fastened in the vehicle floor (not illustrated in any more detail), by the fastening elements 22.2.

The faceplate 22 comprises extensions 23 which project vertically downward in the direction of the first rail 12. The first rail 12 may additionally be laterally entirely or at least partially surrounded, or at least partially covered, by the extensions 23. The extensions 23, for example in the form of walls, extend in the longitudinal direction x laterally with respect to, in particular on both longitudinal sides of, the first rail 12.

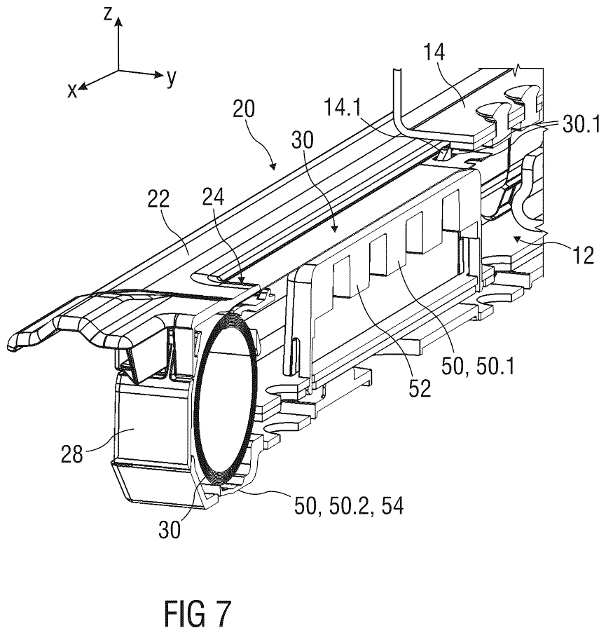

FIG. 7 is a sectional perspective illustration of a detail of the covering device 20 according to the invention for covering the first rail 12, on which the second rail 14 is movably supported.

The covering device 20 comprises the faceplate 22, which has the opening 24. The opening 24 is at least partially closable or coverable by the covering element 30 guided in the faceplate 22. In FIG. 7, the covering element 30 is coupled to the second rail 14 by corresponding coupling elements 30.1, for example detent receptacles or the like, and counterpart coupling elements 14.1, for example detent hooks or the like, and covers the opening 24 between the faceplate 22 and the upper rail 14.

According to the invention, the covering device 20 comprises a plurality of protective units 50. A first protective unit 50.1 is designed for example as a support unit 52. A second protective unit 50.2 is designed for example as a wiper unit 54. The wiper element 40 (shown in FIG. 3) may additionally serve as a further protective unit 50. Each protective unit 50 serves in particular for protecting the covering element 30, in particular for safeguarding a rolling-up function and an unrolling function of the covering element 30.

The wiper unit 54 may in particular be arranged so as to wipe or sweep a surface of the covering element 30, in particular in order to at least partially remove dirt from the surface of the covering element 30. As a protective unit 50, the wiper element 40 may for example be arranged in a region of an entrance of the cassette 28 or on the faceplate 22 in the region of the entrance of the cassette 28, as illustrated in FIG. 3. The wiper unit 54 may additionally or alternatively be arranged, as a protective unit 50, within the cassette 28 for the covering element 30. The wiper unit 54 and/or the wiper element 40 may for example be configured in the form of a brush that is always in contact with the covering element 30, in particular a roll spring. The wiper unit 54 and/or the wiper element 40 may furthermore be provided and configured such that noises between the rolled-up spring regions of the covering element 30 in the form of the roll spring are avoided.

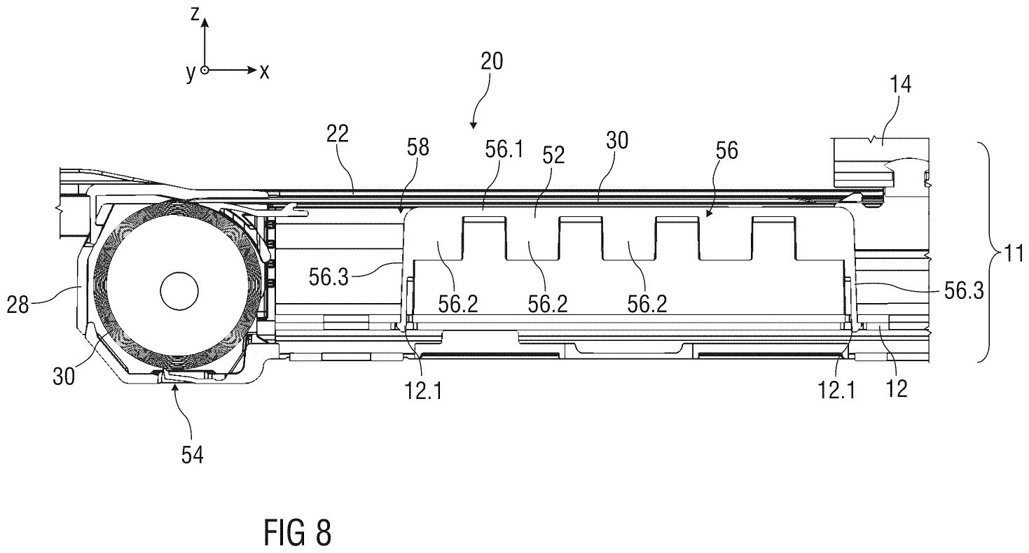

FIG. 8 is a sectional illustration of the covering device 20 according to the invention having protective units 50 designed as a support unit 52 and as a wiper unit 54 and installed on the rail arrangement 11.

The support unit 52 is arranged directly under an underside of the unrolled covering element 30. The covering element 30 is guided on longitudinal sides of the faceplate 22.

The support unit 52 is arranged relative to the underside of the unrolled covering element 30 such that the covering element 30 makes contact with the support unit 52 when a mechanical load acts on the surface of the covering element 30. Undesired deformation of the covering element 30, for example owing to articles falling onto or objects, such as the heel of a shoe, acting upon the covering element 30, can be substantially avoided by way of such contact between the covering element 30 and support unit 52. In particular, a permanent deformation of the covering element 30 after misuse, for example as a result of the action of a high-heeled shoe upon the unrolled covering element 30, can be avoided by way of such a fixed support unit 52 on the underside of the covering element 30.

For example, the support unit 52 is formed as a molded body 56. The molded body 56 may be of solid or block-like form in the direction of the covering element 30. For example, the molded body 56 may have a reinforcement body 56.1 in the direction of the covering element 30. The reinforcement body 56.1 may have dimensions corresponding to the dimensions of the covering element 30. The reinforcement body 56.1 has a planar surface in the direction of the covering element 30. In the direction of the first rail 12, the reinforcement body 56.1 may be equipped with reinforcement ribs 56.2.

In the direction of the first rail 12, the support unit 52, in particular the molded body 56, may be of profiled form. For example, the molded body 56 may have two fastening arms 56.3 which extend vertically in the direction of the first rail 12 from the reinforcement body 56.1. The fastening arms 56.3 engage into corresponding fastening receptacles 12.1 in the first rail 12.

In summary, the support unit 52, in particular the molded body 56, may be formed as a block body, for example a solid molded body, consisting for example of plastics material. Alternatively or in addition, the support unit 52 may be designed as a profiled element, for example a metal bracket or plastics bracket.

The at least one support unit 52 may for example be provided in certain regions for the purposes of safeguarding the covering element 30. For example, the support unit 52 may be provided and arranged in free spaces 58 formed on an underside of the unrolled covering element 30 when the covering element 30 is in the extended or unrolled state (also referred to as rolled-out or unrolled covering element 30). For example, the support unit 52 may be arranged in a free space 58 formed between the second rail 14 and the cassette 28 (also referred to as rolling-up cassette) of the covering element 30.

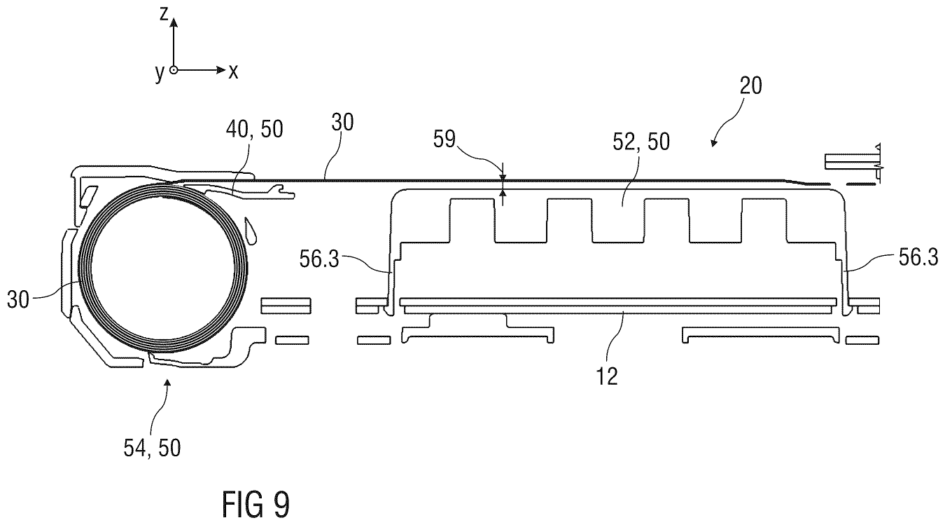

FIG. 9 is a sectional illustration of the covering device 20 according to the invention having protective units 50 designed as a support unit 52, as a wiper element 40 and as a wiper unit 54, wherein the rail arrangement 11 is not illustrated, and the first rail 12 is only partially illustrated.

The support unit 52 is arranged with a predefined spacing 59 to the underside of the unrolled covering element 30 such that, during normal operation, the covering element 30 is able to be rolled up or unrolled further without friction and makes contact with the support unit 52 when a mechanical load acts on the top side of said covering element. In other words: A molded body or plastics beam, for example, is arranged as a support unit 52 under the covering element 30, which is formed for example as a roll-type spring.

Between the support unit 52 and the unrolled covering element 30, there is a small spacing 59 or a small gap that is necessary to avoid bending of the covering element 30 in the event of misuse. Permanent deformation is thus avoided.

The support unit 52 is arranged in an interior of the first rail 12. The support unit 52 is fastened to the first rail 12 by the fastening arms 56.3.

FIG. 10 is a sectional perspective illustration of a detail of the covering device 20 according to the invention installed on the rail arrangement 11, with an installed drive unit 60.

The covering device 20 serves in particular for covering the first rail 12, which is formed as a long rail and which extends for example in the longitudinal direction x of a vehicle, for example a van, over two or more rows of seats. The covering device 20 is provided for the purposes of avoiding contamination of the long rail and in particular of a spindle 62, arranged in said long rail, of the drive unit 60.

The first rail 12, formed as a long rail, allows for example a range of adjustment of 600 mm or more for the second rail 14 (illustrated in FIG. 7 or 9), which is formed as a carriage or top rail and which is connected to one of the adjustable vehicle seats 1.

The spindle 62 serves as a carrier for the unrolled covering element 30. A spindle holder 64 also serves as a carrier for the unrolled covering element 30.

The support unit 52 is arranged, as protective unit 50, in the free space 58 between the drive unit 60 and the cassette 28 for the covering element 30 in order to support and protect the covering element 30.

FIG. 11 is a sectional illustration of a detail of the covering device 20 according to the invention, partially omitting the rail arrangement 11 according to FIG. 10 and partially illustrating the drive unit 60 according to FIG. 10. The spindle holder 64 is not illustrated. Only the first rail 12, the cassette 28 for the covering element 30 and the faceplate 22 in the region of the cassette 28 are illustrated.

In a spindle region 100, the spindle 62 serves as a protective unit 50 and carrier for the covering element 30. In a holder region 102, the spindle holder 64 shown in FIG. 10 serves as a protective unit 50 and carrier for the covering element 30. A free region 103 serves to provide access to the screws for fastening the first rail 12 in the vehicle. In a support region 104, the support unit 52 serves as a protective unit 50 and carrier for the covering element 30.

There is a relatively large spacing in the longitudinal direction x between the support region 104 and spindle region 100 because the spindle holder 64 (illustrated in FIG. 10) serves as a carrier in the holder region 102. The free region 103 must be small enough that maloperation forces exerted on the covering element 30 from above cannot cause deformation.

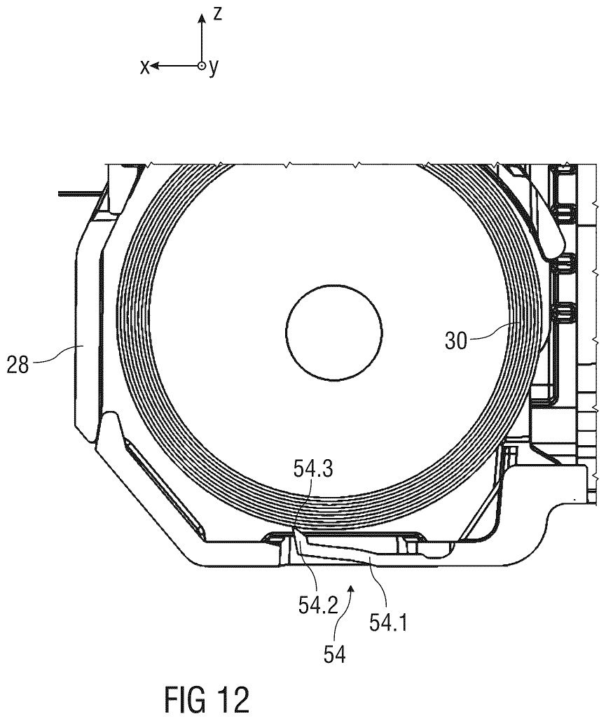

FIG. 12 is a sectional detail illustration of the cassette 28 with a rolled-up covering element 30 and with a wiper unit 54 for the covering element 30.

The wiper unit 54 may in particular be arranged so as to always be in contact with the covering element 30, for example the roll spring, in particular a constant spring with rolling-up capability or a spiral spring with rolling-up capability. In particular, the wiper unit 54 is in permanent contact with the covering element 30 irrespective of whether the covering element 30 is rolled up (also referred to as wound up) or unrolled (also referred to as unwound).

For example, the wiper unit 54 is arranged so as to wipe or sweep a surface of the covering element 30 before it is rolled out or unrolled and before it is rolled up again or rolled in again.

The wiper unit 54 may for example be of flexible form. For example, the wiper unit 54 comprises a spring arm 54.1. The spring force of the wiper unit 54, in particular of the spring arm 54.1, is for example configured such that the wiper unit 54 is always in contact with the surface of the covering element 30.

In addition or alternatively, the wiper unit 54 may also establish the permanent contact with the covering element 30 by way of a geometry and elasticity. For example, the wiper unit 54 is formed as a plastics spring element. Furthermore, an additional spring may be provided for the wiper unit 54, which additional spring generates a constant spring force for maintaining the permanent contact with the covering element 30 irrespective of temperature fluctuations.

The wiper unit 54 may furthermore have a wiper lip 54.2 and/or a wiper edge 54.3 that is in contact with the surface of the covering element 30. For example, the wiper lip 54.2 and/or the wiper edge 54.3 is provided on a free end of the spring arm 54.1. For example, the wiper lip 54.2 is formed as a sharp wiper lip. In particular, the wiper lip 54.2 may be formed as a sharp rubber lip. The wiper edge 54.3 may be formed as a sharp wiper edge 54.3. Alternatively, the wiper edge 54.3 may be formed as a brush edge and equipped with bristles. In particular, the wiper lip 54.2 and/or the wiper edge 54.3 extends transversely with respect to the rolling-up direction or unrolling direction of the covering element 30 and over the entire width of the covering element 30.

The spring arm 54.1 is for example punched out of the cassette 28. The wiper edge 54.3 and/or the wiper lip 54.2 project from the spring arm 54.1 in the direction of the covering element 30. The spring arm 54.1 is inclined and preloaded in the direction of the interior of the cassette 28.

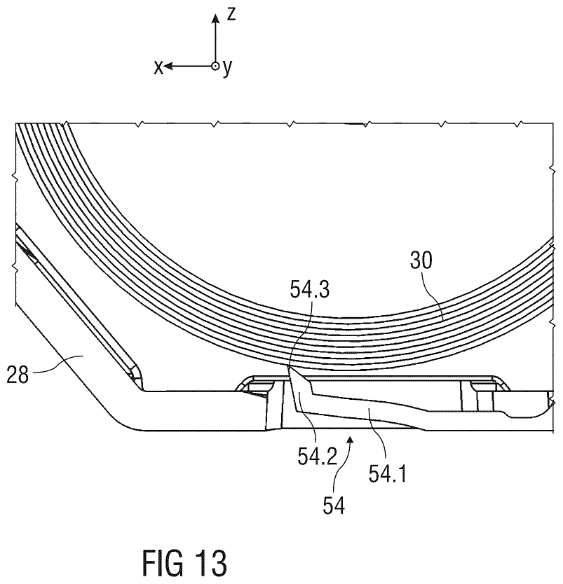

FIG. 13 is an enlarged view of the sectional illustration according to FIG. 12 in the region of the wiper unit 54.

The wiper unit 54 takes the form in particular of the spring arm 54.1, which is formed as a single piece and is partially cut or punched or formed out of a wall, in particular a base wall, of the cassette 28 and has the integrated, in particular integrally formed, wiper lip 54.2 and/or wiper edge 54.3.

The spring arm 54.1 is inclined relative to the plane of the wall or the plane of the base of the cassette 28 and is preloaded such that the wiper lip 54.2 and/or the wiper edge 54.3 are/is always in contact with the surface of the covering element 30.

The features disclosed in the above description, in the claims and in the figures may be both individually and collectively of importance for the implementation of the invention in its various embodiments.

Although the invention has been described in detail in the drawings and in the statements above, the statements are illustrative and exemplary and are not to be understood as limiting. In particular, the selection of the proportions of the individual elements as illustrated in the drawings is not to be interpreted as necessary or limiting. Furthermore, the invention is in particular not restricted to the exemplary embodiments discussed. Further variants of the invention and its design are apparent to a person skilled in the art from the above disclosure, the figures and the claims.

Terms such as “comprise”, have”, “include” and “contain” and the like used in the claims do not rule out other elements or steps. The use of the indefinite article does not rule out a plurality. A single device may perform the functions of a plurality of units or devices mentioned in the claims.

### LIST OF REFERENCE SIGNS

1 Vehicle seat
2 Seat part
4 Backrest
10 Longitudinal adjuster
11 Rail arrangement
12 First rail
12.1 Fastening receptacle
13 Rail opening
14 Second rail
14.1 Counterpart coupling element
20 Covering device
22 Faceplate
22.1 Longitudinal end
22.2 Fastening element
23 Extension
24 Opening
26 Guide channel
28 Cassette
29 Housing opening
30 Covering element
30.1 Coupling element
30a First end
30b Second end
32 Edge portion
34 Holding device
35 Support element
36 Strut
38 Roller
40 Wiper element
42 Projection
44 Side covering
50 Protective unit
50.1 First protective unit
50.2 Second protective unit
52 Support unit
54 Wiper unit
54.1 Spring arm
54.2 Wiper lip
54.3 Wiper edge
56 Molded body
56.1 Reinforcement body
56.2 Reinforcement ribs
56.3 Fastening arm
58 Free space
59 Spacing
60 Drive unit
62 Spindle
64 Spindle holder
100 Spindle region
102 Holder region
103 Free region
104 Support region
F1 Force
F2 Force
L1 Length of the first rail
L2 Length of the second rail
X Longitudinal direction
y Transverse direction
Z Vertical direction

1-12. (canceled)

13. A covering device for covering a rail of a longitudinal adjuster for a vehicle seat,
wherein the covering device has a faceplate having an opening that is at least partially closable by at least one movable covering element that is guided in the faceplate, characterized in that at least one protective unit is provided for safeguarding the covering element.

14. The covering device as claimed in claim 13, characterized in that, as a first protective unit, a support unit is arranged under an underside of the unrolled covering element.

15. The covering device as claimed in claim 14, characterized in that the support unit is arranged with a predefined spacing to the underside of the unrolled covering element such that, during normal operation, the covering element is able to be rolled up or unrolled without friction and makes contact with the support unit when a mechanical load acts on the surface of the unrolled covering element.

16. The covering device as claimed in claim 14, characterized in that the support unit is formed as a profiled element, a molded body and/or a block body.

17. The covering device as claimed in claim 14, characterized in that the support unit is arranged in a free space formed between a spindle and a cassette of the covering element.

18. The covering device as claimed in claim 13, characterized in that, as a second protective unit, a wiper unit is provided and is arranged so as to wipe a surface of the covering element before it is rolled up or unrolled.

19. The covering device as claimed in claim 18, characterized in that the wiper unit has a wiper lip and/or a wiper edge that is in contact with the surface of the covering element.

20. The covering device as claimed in claim 18, characterized in that the wiper unit has a flexible arm or spring arm, on the free end of which there is provided a wiper lip and/or a wiper edge that is in contact with the surface of the covering element.

21. The covering device as claimed in claim 19, characterized in that the wiper lip is formed as a rubber lip.

22. The covering device as claimed in claim 19, characterized in that the wiper lip and/or the wiper edge extends transversely with respect to the rolling-up direction or unrolling direction and over the entire width of the covering element.

23. A longitudinal adjuster for a motor vehicle seat, wherein the longitudinal adjuster comprises at least one first rail and at least one second rail arranged so as to be movable relative to the first rail,
characterized in that
the first rail has the covering device as claimed in claim 13.

24. A vehicle seat having a longitudinal adjuster as claimed in claim 23.
